(19) United States
(12) Patent Application Publication
(10) Pub. No.: US 2010/0009182 A1
(43) Pub. Date: Jan. 14, 2010

(54) PEELABLE ADHESIVE SHEET, METHOD FOR RECORDING IMAGES AND METHOD FOR MANUFACTURING PEELABLE LAMINATED BODY

(75) Inventors: Atsushi KATO, Shizuoka-ken (JP); Hirofumi MITSUO, Shizuoka-ken (JP)

Correspondence Address: Moss & Burke, PLLC, 401 Holland Lane, Suite 407, Alexandria, VA, 22314, US

(73) Assignee: FUJIFILM CORPORATION, Tokyo (JP)

(21) Appl. No.: 12/499,088

(22) Filed: Jul. 8, 2009

(30) Foreign Application Priority Data
Jul. 10, 2008 (JP) 2008-180206

(51) Int. Cl. C09J 7/02; B32B 5/16; B32B 27/30; G03G 15/20

(52) U.S. Cl. 428/355 RA; 428/323; 428/340; 156/327; 156/227; 399/330

(57) ABSTRACT

A peelable adhesive sheet is provided. The peelable adhesive sheet includes a base material and an adhesive composition layer that is provided to at least one side of the base material and that contains an acrylic resin and hollow particles. The adhesive composition layer is configured to removably adhere to another adhesive layer when at least two adhesive composition layers at least contact each other and at least pressure is applied thereto.

### CROSS-REFERENCE TO RELATED APPLICATION

This application claims priority under 35 USC 119 from Japanese Patent Application No. 2008-180206 filed on Jul. 10, 2008, the disclosure of which is incorporated by reference herein.

### BACKGROUND OF THE INVENTION

1. Field of the Invention

The present invention relates to a peelable adhesive sheet, a method for forming images for the peelable adhesive sheet and a method for manufacturing a peelable laminated body.

2. Description of the Related Art

In recent years, postcards have been developed that have postal charges lower than those of sealed letters but which can maintain the confidentiality of messages thereon just like sealed letters. Among these are pressure-adhering postcards in which, first, various information is printed on the surface of a pressure sensitive adhesive composition layer which is formed on a paper base in a pressure-adhering paper and which has peelability with respect to a paper base material, to form a confidential surface, and then subsequently the paper material is folded two or three times and confidential surfaces are peelably (removably) adhered with each other by applying a high pressure, such as 50 to 100 kg/cm², to form a postcard. Postcards such as these are in widespread use in business fields that require the sending of a large volume of notification documents.

With such pressure-adhering postcards, it is required that the confidential surfaces are adhered with each other with an appropriate strength (that is, no adhesion failure exists) before the postcard is delivered to the addressee thereof and the adhered surfaces are separated. This is because if the adhesion strength between the confidential surfaces is too weak, the adhered surfaces may be separated before the card is delivered to the addressee, and if the adhesion strength between the confidential surfaces is too strong, occasionally the information on the confidential surface can not be read because the addressee can not separate the adhered surfaces cleanly, or paper layers are destroyed when the adhered surfaces are separated.

In recent years, pressure-adhering postcards are often printed with a photograph-like printing on the confidential surface, and an impression of high glossiness is required for the confidential surface. For example, a layer with high glossiness, such as a thin aqueous varnish layer or UV varnish layer, which is provided on a printed material to which a transparent thermoplastic resin film is adhered is known.

In addition, a peelable pressure-sensitive adhesive sheet, to which glossiness is provided by forming a peelable adhesive layer that contains resin particles to attain a specific plane smoothness, is also known (see, for example, Japanese Patent No. 3701359).

Meanwhile, as a system for forming an image onto the confidential surface, a printing system using an electrophotographic printer of a heat roll fixing system is frequently utilized as a method for forming an image of various kinds of information onto the pressure-adhering postcard, in consideration of the advantages of printing stability and printing speed. However, with electrophotographic printers of a heat roll fixing system, in order to prevent toner being transferred to a heat roll for fixing the toner onto a sheet, oil is sometimes included in the toner, or silicone oil is coated on the heat roll. As a result, when forming an image on the confidential surface using an electrophotographic printer of a heat roll fixing system, there may be problems of adhesion failure, since the surfaces cannot be adhered with an ordinary pressure application or the adhesion strength becomes very weak, due to the adherence of the oil onto the surface of the pressure sensitive adhesive layer which is to be the confidential surface.

For this, there is known a base paper for pressure-bondable postcards that is provided with a layer of a pressure sensitive adhesive composition containing a cold sealing agent and a fine particulate filler at a specific ratio (see, for example, JP-A No. 2008-25051).

### SUMMARY OF THE INVENTION

In the electrophotographic system, there is a problem that in printing or image formation achieved by accumulating a toner and fixing the toner by heat roll fixing, unevenness may be caused in the fixed toner layer due to the difference in the toner accumulation volume, which results in an uneven impression of glossiness.

Further, the peelable pressure sensitive adhesive sheet described in Japanese Patent No. 3701359 occasionally generates adhesion failure when an image is formed thereon by an electrophotographic system. Further, the confidential surface of the base paper for pressure-bondable postcards described in JP-A No. 2008-25051 has insufficient gloss properties.

The present invention has been made in view of the above circumstances.

According to a first aspect of the invention, a peelable adhesive sheet is provided. The peelable adhesive sheet of the first aspect includes a base material and an adhesive composition layer that is provided to at least one side of the base material and that contains an acrylic resin and hollow particles. The adhesive composition layer is configured to removably adhere to another adhesive layer when at least two adhesive composition layers at least partially contact each other and at least pressure is applied thereto.

According to a second aspect of the invention, a method for recording an image is provided. The method for recording an image of the second aspect includes recording an image on the adhesive composition layer of the peelable adhesive sheet of the first aspect using an electrophotographic printer of a heat roll fixing system.

According to a third aspect of the invention, a method for manufacturing a peelable laminated body is provided. The method for manufacturing a peelable laminated body of the third aspect includes placing the adhesive composition layers, each of which is provided on or above the base material of the peelable adhesive sheet of the first aspect, so that they overlap; and applying at least one of heat or pressure from the side of the base material opposite to the side on which the overlapped adhesive composition layers are provided, to adhere the adhesive composition layers to each other at a temperature of 70° C. or less.

### DETAILED DESCRIPTION OF THE INVENTION

### Peelable Adhesive Sheet

The peelable adhesive sheet of the present invention includes a base material and an adhesive composition layer that contains an acrylic resin and hollow particles and is provided to at least one side of the base material. By incorporating the acrylic resin and the hollow particles in the adhesive composition layer, it becomes possible to suppress generation of the adhesion failure and, further, to give a good impression of glossiness to images to be formed.

The peelable adhesive sheet in the invention means an image recording medium including a base material and an adhesive composition layer provided on the base material, and when the adhesive composition layers are placed so as to at least partially contact each other, and at least the pressure is applied thereto, the adhesive composition layers are peelably (removably) adhered to each other.

The term “peelable” or “removable” used herein means that after the pressure is applied to effect adhesion, the adhered surfaces are removable (peelable). In the peelable adhesive sheet of the present invention, once the surfaces have been adhered, and then the adhered surfaces are removed (peeled), the removed (peeled) surface does not have adhesiveness.

(Base Material)

On the base material in the peelable adhesive sheet of the invention, no particular limitation is imposed as long as it is a base material capable of having an adhesive composition layer on at least one side thereof. Examples of paper base materials include various kinds of paper for information, such as kraft paper, form paper, high quality paper, medium quality paper and an OCR form. Examples of base materials other than the paper include resin coated paper prepared by laminating a thermoplastic resin, such as polyethylene, polypropylene or polymethylpentene, on a paper base material; plastic films such as polyethylene terephthalate, polypropylene, polyethylene, polyvinyl chloride, polystyrene, polycarbonate and triacetate, sheets that are prepared by at least uniaxially stretching polyethylene, polypropylene or polyethylene terephthalate and have a void, sheets prepared by laminating these plastic films or sheets having a void to a paper base material, and sheets of impregnated paper, glassine and the like.

As the base material, from the viewpoint of the application to postcards, it is preferably opaque, and, more preferably, has opacity of 85% or more.

When the base material is a paper base material, the basis weight thereof can be from 52 to 256 g/m² and, for example, in light of the application to postcards, is preferably from 64 to 210 g/m².

The base material in the invention is preferably a sheet including a paper base material having the opacity of 85% or more and the basis weight of from 52 to 256 g/m², and, more preferably a sheet including a paper base material having the opacity of 85% or more and the basis weight of from 64 to 210 g/m².

(Adhesive Composition Layer)

The peelable adhesive sheet of the invention includes an adhesive composition layer provided on at least one surface of a base material. In the invention, the adhesive composition layer may be provided on only one side of the base material or on both sides of the base material in accordance with the application of the peelable adhesive sheet. Further, the adhesive composition layer may be provided on the entire surface of at least one side of the base material, or the adhesive composition layer may be provided on only a part of the surface.

The adhesive composition layer in the invention includes at least one kind of acrylic resins and at least one kind of hollow particles, and, according to need, the adhesive composition layer may contain other additives.

—Acrylic Resin—

The adhesive composition layer in the invention contains at least one kind of acrylic resin. On the acrylic resin, no particular limitation is imposed as long as it is an acrylic resin capable of peelably adhering property to the adhesive composition layer, whereby the adhesive composition layers are peelably adhered to each other when at least pressure is applied to the adhesive composition layers. Examples thereof include an acrylic resin including at least an ethylenically unsaturated carboxylic acid monomer derived component and a (meth)acrylic acid ester monomer derived component.

Examples of the ethylenically unsaturated carboxylic acid monomer include monocarboxylic acids such as acrylic acid, (meth)acrylic acid and crotonic acid, dicarboxylic acids such as maleic acid, fumaric acid and itaconic acid, half-esters such as methyl maleate, methyl itaconate and β-methacryloxyethyl acid hexahydrophthalate, anhydrides of any of these unsaturated carboxylic acids, for example, acrylic acid anhydride and maleic acid anhydride. Further, these may be used in one kind alone or in two or more kinds in combination, and any of potassium, sodium and ammonium salts thereof may also be employed.

Examples of the (meth)acrylic acid ester monomer include (meth)acrylic acid alkyl esters such as methyl(meth)acrylate, ethyl(meth)acrylate, n-propyl(meth)acrylate, i-propyl (meth)acrylate, n-butyl(meth)acrylate, i-butyl(meth)acrylate, n-amyl(meth)acrylate, i-amyl (meth)acrylate, n-hexyl(meth)acrylate, cyclohexyl(meth)acrylate, 2-ethylhexyl (meth)acrylate, octyl(meth)acrylate, i-nonyl(meth)acrylate, t-butylcyclohexyl(meth)acrylate, decyl(meth)acrylate, dodecyl(meth)acrylate, hydroxymethyl(meth)acrylate and hydroxyethyl(meth)acrylate; aminoalkyl esters of an ethylenically unsaturated carboxylic acid such as aminoethyl acrylate, dimethylaminoethyl acrylate and butylaminoethyl acrylate; compounds containing a carbonyl group in a molecule such as diacetone (meth)acrylamide; (meth)acrylates having any of various kinds of functional groups such as N-methylol (meth)acrylamide and γ-(meth)acryloxypropyl trimethoxysilane; polyfunctional (meth)acrylates such as ethylene glycol di(meth)acrylate and trimethylolpropane tri(meth)acrylate; (meth)acrylates having a light stabilizing function such as 1,2,2,6,6-pentamethyl-4-piperidyl methacrylate, 2,2,6,6-tetramethyl-4-piperidyl methacrylate; (meth)acrylate compounds having an ultraviolet ray absorbing function such as 2-hydroxy-4-methacryloxy benzophenone and 2-[2′-hydroxy-5-methacryloxyethyl]phenyl)benzotriazole; aliphatic conjugated dienes such as 1,3-butadiene, isoprene and 2-chloro-1,3-butadiene; carboxylic acid vinyl esters such as vinyl acetate and vinyl propionate; acid anhydrides, monoalkyl esters and monoamides of ethylenically unsaturated dicarboxylic acids; vinyl cyanate compounds such as (meth)acrylonitrile and α-chloroacrylonitrile, acrolein, formylstyrol, vinyl methyl ketone, vinyl ethyl ketone and vinyl butyl ketone. These may be used in one kind alone or in two or more kinds in combination.

Further, in addition to the above-described monomers, an aromatic ethylenically unsaturated monomer may be used. Examples thereof include aromatic vinyl compounds such as styrene, α-methyl styrene, vinyl toluene and ethylvinylbenzene, and (meth)acrylates having an aromatic ring such as benzyl(meth)acrylate and benzoyl(meth)acrylate. A monomer having any functional group selected from an epoxy group, a hydroxyl group, a silanol group and a methylol group may be used.

The acrylic resin in the invention is preferably in a form of an aqueous system or an aqueous dispersion from the viewpoint of easy handling and environmental impacts, and more preferably in an form of an aqueous dispersion.

When the acrylic resin in the invention is in a form of an aqueous dispersion, the aqueous dispersion preferably contains polymer particles of an acrylic resin obtained by emulsion polymerization, and more preferably contains polymer particles of a carboxy-modified acrylic resin.

(Volume Average Particle Diameter)

The volume average particle diameter of the polymer particles is preferably 200 nm or less, more preferably from 30 to 200 nm, still more preferably from 30 to 150 nm, and further preferably from 50 to 100 nm. When the volume average diameter of the polymer particles is 200 nm or less, the adhesion failure may be more effectively suppressed. The volume average particle diameter is measured according to the following method. The aqueous dispersion of the particles is appropriately diluted with distilled water, and the volume average particle diameter is measured using a particle diameter measurement device of the dynamic light scattering method. The average particle diameter of polymer particles can be controlled by adjusting the kind and the amount of a radical polymerization initiator and an emulsifying agent.

(Gel Ratio)

The gel ratio of the polymer particles contained in the aqueous dispersion is preferably 30% or more, more preferably 40% or more, and further preferably 60% or more. When the gel ratio is 40% or more, it is possible to suppress the generation of adhesion failure at a temperature and humidity condition under natural environments. As described above, the gel ratio means a ratio occupied by a part forming a high molecular weight three dimensional net-like structure in the polymer particle, and is usually measured as a inorganic solvent (such as toluene) insoluble portion in the polymer particle.

With respect to the acrylic resin in the invention, the glass transition temperature Tg thereof is preferably from −40 to +30° C., more preferably from −30 to +20° C., and further preferable from −20 to +15° C. from the viewpoint of suppressing generation of the adhesion failure.

The glass transition temperature Tg of an acrylic resin can be controlled by a publicly known method. For example, an acrylic resin having an intended glass transition temperature Tg can be obtained by appropriately selecting a monomer used for preparing the acrylic resin, or by controlling the molecular weight of the acrylic resin. Further, a commercially available acrylic resin may appropriately be selected and used.

The polymer particles preferably have a glass transition temperature Tg of from −40 to +30° C. and a volume average particle diameter of from 30 to 200 nm, more preferably a glass transition temperature Tg of from −30 to +20° C. and a volume average particle diameter of from 30 to 150 nm, further preferably, a glass transition temperature Tg of from −20 to +15° C. and a volume average particle diameter of from 50 to 100 nm,

—Hollow Particles—

The adhesive composition layer contains at least one kind of hollow particles. This makes it possible to form an image that has a good impression of glossiness even after the peeling of the adhered surfaces even when an electrophotographic printer of a heat roll fixing system is used.

The hollow particle in the invention means a hollow particle that contains air or other gas in the inner portion that is surrounded by the shell portion of a thermoplastic resin and is in a foamed state.

The surface of the follow particles of thermoplastic resin is approximately smooth, and has little oil-absorbing property. Therefore, even after an image is formed by using an electrophotographic printer, the occurrence of adhesion failure may be suppressed.

On the shape of the hollow particle, no particular limitation is imposed. It may have any of various shapes such as spherical, flat and indeterminate, but preferably has a spherical shape. The hollow particles are preferably not deformed or broken when the adhesive composition layer is formed on the base material. The volume average particle diameter of the hollow particles is preferably 0.3 μm or more, more preferably from 0.3 μm to 3 μm, and further preferably from 0.6 μm to 1.5 μm. When the hollow particle having the average particle diameter in the above-described range are used, images having a better impression of glossiness can be formed.

The volume average particle diameter can be obtained by a publicly known method. For example, it can be measured using the particle diameter measurement by electron microscope observation or a particle diameter measurement apparatus of a laser diffraction system.

The hollow particles have a hollow ratio of preferably from 20% to 95%, more preferably from 30% to 70% and further preferably from 50% to 70%, the hollowness ratio being defined as (inner diameter of a hollow particle/outer diameter of a hollow particle)×100 (%). Here, the inner and outer diameters of the hollow particles can be obtained from the particle diameter measurement by electron microscope observation.

On the material that is used for the shell portion of the hollow particles, no particular limitation is imposed, and it is appropriately selected in accordance with the purpose. Examples thereof include styrene-based polymer, acrylic polymer, styrene-acrylic copolymer such as styrene-acrylonitrile copolymer and styrene-acrylonitrile-butadiene copolymer; polypropylene resin, polyvinyl chloride resin, polyvinylidene chloride resin, vinyl-based copolymer, urea-formalin resin and the like. Among these, styrene-acrylic copolymer is particularly preferable.

Further, as the hollow particles, crosslinked type hollow particle may be employed preferably. The crosslinked hollow particle means that a resin used for the shell of the hollow particle is crosslinked by some method. For example, for the hollow particles having a styrene-acrylic copolymer as the main component, it denotes hollow particles in which the resin used for the shell is crosslinked with divinylbenzene or the like when the particles are synthesized. As a guide for a degree of the crosslinking, when 100 mg of dried hollow particles are added to a liquid prepared by mixing methyl ethyl ketone and toluene at a mass ratio of 1:1 and the mixture is stirred at an ordinary temperature for 8 hours, the remained solid matter is preferably in an amount of 60% by mass or more relative to the amount of the dried hollow particles added to the liquid.

No particular limitation is imposed on the hollow particles, and commercially available products may be used. Examples of commercially available ones include HP-1055, HP-91, HP-433J, AF-1353, OP-84J and LOWPAQUE ST manufactured by Rohm and Haas; MH-5055 manufactured by ZEON Corporation; SX866(B), SX8782(A) and SX8783(P) manufactured by JSR; SHP-100 manufactured by Samji Chemical; and the like.

The mass (content) of the hollow particles in the adhesive composition layer is preferably 0.5 g/m² or more, more preferably 0.75 g/m² or more, and further preferably from 1.0 g/m² to 11g/m². When the mass (content) of the hollow particles is 0.5 g/m² or more, the occurrence of a mark of the roller upon performing heat roll fixing may be suppressed, and it is also possible to obtain images having sufficient gloss.

The mass of the hollow particles can be determined, for example, by calculation on the basis of the difference in the mass between before and after the coating, and the hollow particle ratio of the coating liquid, or by measurement after removing the coated layer and separating the hollow particle from the binder and other additives.

The hollow particles in the invention preferably have the volume average particle diameter of 0.3 μm or more and the hollowness ratio of 30% or more. The hollow particles in the invention more preferably have the volume average particle diameter of from 0.3 μm to 3 μm and the hollowness ratio or from 30% to 70%, and the hollow particles further preferably have the volume average particle diameter of from 0.6 μm to 1.5 μm and the hollowness ratio of from 50 to 70%.

The hollow particle may be used in one kind alone, or in two or more kinds in combination.

In the invention, the content ratio of the acrylic resin and the hollow particle (acrylic resin: hollow particle) in the adhesive composition layer is preferably from 80:20 to 10:90, and more preferably from 70:30 to 20:80, based on mass, from the view point of suppressing the adhesion failure and giving an impression of glossiness.

In addition, from the viewpoint of suppressing the adhesion failure and giving an impression of glossiness, the adhesive composition layer in the invention preferably contains an acrylic resin having Tg of from −40° C. to +30° C. and hollow particles having a volume average particle diameter of from 0.3 μm to 3 μm and the hollowness ratio of from 30% to 70% in a content ratio of the acrylic resin to the hollow particles (acrylic resin: hollow particle) of from 80:20 to 10:90, and more preferably contains an acrylic resin having Tg of from −30 to +20° C. and hollow particles having a volume average particle diameter of from 0.6 μm to 1.5 μm and the hollowness ratio of from 50% to 70% in a content ratio of the acrylic resin to the hollow particles (acrylic resin: hollow particle) of from 70:30 to 20:80.

The adhesive composition layer containing an acrylic resin and hollow particles is constituted of at least one layer, but, from the viewpoint of suppressing generation of the adhesion failure and giving an impression of glossiness, it is preferably constituted of two or more layers.

When the adhesive composition layer is constituted of two or more layers, the coating amount of respective layers and the content ratio of the acrylic resin and the hollow particles in respective layers may appropriately be changed in accordance with the purpose. The coating amount and the content ratio of the acrylic resin and the hollow particles in respective layers may appropriately be selected so as to give the above-described preferable ranges of the coating amount and the content ratio in the adhesive composition layer. For example, regarding the content ratio of the acrylic resin and the hollow particles in the layer on the side of image formation, from the viewpoint of suppressing generation of the adhesion failure, an increased ratio of the acrylic resin is preferable, and, from the viewpoint of an impression of glossiness, an increased ratio of the hollow particle is preferable.

Further, according to need, the adhesive composition layer may contain publicly known additives that are usually used in the technical field such as a defoaming agent, a thickening agent, a pH adjusting agent, a lubricant, a dispersing agent, a wetting agent, dye and an antiseptic agent.

The peelable adhesive sheet of the invention can be produced, for example, by a manufacturing method including a process of coating a coating liquid for forming an adhesive composition layer onto a base material. The manufacturing method may include another process, such as drying process, according to need.

On the method for coating the coating liquid for forming an adhesive composition layer, no particular limitation is imposed and usually employed coating methods can appropriately be used. Examples of the method include a blade coating, an air knife coating, a roll coating, a reverse roll coating, a curtain coating, a bar coating, a gravure coating methods, and the like.

The coating liquid for forming an adhesive composition layer may include at least one kind of solvent in addition to the acrylic resin and the hollow particles, and may contain additional additive(s) according to need. Examples of the solvent include water, alcohols such as methanol, ethanol, butanol, IPA (isopropyl alcohol), n-propyl alcohol, butanol, TBA (tert-butanol), butanediol, ethyl hexanol and benzyl alcohol, ethers such as methyl cellosolve, cellosolve, butyl cellosolve, dioxane, MTBE (methyl tert-butanol) and butyl carbitol, glycols such as ethylene glycol, diethylene glycol, triethylene glycol and propylene glycol, glycol ethers such as diethylene glycol monomethyl ether, triethylene glycol monomethyl ether, propylene glycol monomethyl ether and 3-methoxy-3-methyl-1-butanol, and glycol esters such as ethylene glycol monomethyl ether acetate, PMA (propylene glycol monomethyl ether acetate), diethylene glycol monobutyl ether acetate and diethylene glycol monoethyl ether acetate, and the like.

In the invention, on the solid content of the layer of the adhesive composition provided on the base material, no particular limitation is imposed as long as the generation of the adhesion failure may be inhibited, and the content may be, for example, from 1 g/m to 25 g/m². In the invention, the content is preferably from 3 g/m² to 20 g/m², and more preferably from 5 g/m² to 15 g/m², from the viewpoint of suppressing generation of the adhesion failure.

The thickness of the adhesive composition layer provided on the base material is preferably 1 μm or more, more preferably from 3 μm to 40 μm, and further preferably from 5 μm to 30 μm, from the viewpoint of suppressing generation of the adhesion failure and giving an impression of glossiness.

<Image Recording Method>

The method for forming an image on the peelable adhesive sheet of the invention includes a step of recording an image on the adhesive composition layer of the peelable adhesive sheet using an electrophotographic printer of a heat roll fixing system. By recording an image on the adhesive composition layer by an electrophotographic system, it is possible to suppress generation of the adhesion failure, and to form an image which has an impression of glossiness even after the peeling.

On the electrophotographic printer for use in the invention, no particular limitation is imposed, as long as it is an electrophotographic printer of a heat roll fixing system, and any apparatuses having a structure which is usually used in the technical field can be employed. The method of for forming an image of the invention preferably includes forming a toner image (a toner image forming step) and fixing (a fixing step), and may further include other steps according to need.

—Toner Image Forming Step—

The toner image forming step is a step for forming a toner image on the adhesive composition layer of the peelable adhesive sheet of the invention.

On the toner image forming step, no particular limitation is imposed on the method thereof as long as a toner image can be formed on the peelable adhesive sheet, and the method can appropriately be selected in accordance with the purpose. Examples of the method include a method which is used in usual electrophotographic methods, including, for example, a direct transfer system in which a toner image formed on a developing roller is transferred to the peelable adhesive sheet, and an intermediate transfer belt system in which the image is once transferred to an intermediated transfer belt and then transferred to the peelable adhesive sheet. Among these, the intermediate transfer belt system can favorably be employed from the standpoint of environmental stability and high image quality.

—Fixing Step—

The fixing step is a step for fixing a toner image formed in the above-described toner image forming step with a heating and pressurizing member.

Examples of the heating and pressurizing member include a pair of heating rollers, a combination of a heating roller and a pressurizing roller, and the like.

On the method of the pressurizing method, no particular limitation is imposed and the method can be selected in accordance with the purpose, and nip pressure is preferably adopted. The nip pressure is preferably from 0.098 MPa to 9.8 MPa, and more preferably from 0.49 MPa to 2.94 MPa, from the viewpoint of forming an image having water resistance, excellent surface flatness and good gloss. Further, the heating with the heating and pressurizing member is preferably performed at from 80 to 210° C.

<Method for Manufacturing Peelable Laminated Body>

The manufacturing method of a peelable laminated body of the invention includes placing the adhesive composition layers, each of which is provided on or above the base material of the peelable adhesive sheet, so that they overlap, and applying at least one of heat or pressure from the side of the base material opposite to the side on which the overlapped adhesive composition layers are provided, to adhere the adhesive composition layers to each other at a temperature of 70° C. or less. The method may include other steps according to need.

By adhering the adhesive composition layers to each other at a temperature of 70° C. or less, it is possible to obtain images that have a good impression of glossiness after the peeling of the adhered surfaces.

In the invention, the method of placing the adhesive composition layers so that they overlap is not particularly limited. Any of methods for overlapping publicly known in the technical field can be employed. Examples of the method include a method in which two peelable adhesive sheets are placed such that the adhesive composition layer of one of the two peelable adhesive sheets contacts the adhesive composition layer of the other peelable adhesive sheet; a method in which one peelable adhesive sheet is folded into two parts and the adhesive composition layer of one of the two parts contacts the adhesive composition layer of the other part; a method in which the adhesive composition layer is provided on both sides of the base paper, and the peelable adhesive sheet is folded into three parts such that the adhesive composition layers on two adjacent parts on one side of the peelable laminated sheet at least partially contact each other, and the adhesive composition layers on two adjacent parts on the other side of the peelable laminated sheet at least partially contact each other; and the like.

In the step of applying at least one of heat or pressure to adhere the adhesive composition layers to each other (a step of adhering the adhesive composition layers to each other) in the invention, a treatment of applying at least one of heat and pressure is performed at a temperature of 70° C. or less. On this occasion, from the viewpoint of suppressing the adhesion failure, giving an impression of glossiness and preventing the blocking of toner particles used for forming an image on the adhesive composition with each other, the step is performed preferably at a temperature of from 20° C. to 70° C., and more preferably from 30° C. to 65° C.

In the step of adhering the adhesive composition to each other, at least one of heat and pressure is applied. When pressure is applied, the pressure is preferably from 0.5 MPa to 20 MPa, and more preferably from 1 MPa to 10 MPa, from the viewpoint of the suppressing the adhesion failure and giving the glossy feeling.

In the invention, preferably the adhesive composition layers are adhered by applying heat and pressure, more preferably the adhesive composition layers are adhered at a temperature of from 20° C. to 70° C. while applying a pressure of from 0.5 MPa to 20 MPa, and more preferably the adhesive composition layers are adhered at a temperature of from 30° C. to 65° C. while applying a pressure of from 1 MPa to 10 MPa.

For the method for applying at least one of heat and pressure in the invention, publicly known methods in the technical field can be employed with no particular limitation. Examples of the method include a method using a device such as PRESSLE Ace, PRESSLE Neo, PRESSLE TiVO or PRESSLE LiTTA (manufactured by TECHNO TOPPAN FORMS), EX-4100-4500, EX-4000 and EX-2000 (manufactured by Duplo), HALLO MAKER A502V-11 (manufactured by Nippon Business Form), or the like.

### EXAMPLES

Hereinafter, the present invention is described more specifically on the basis of Examples, but the invention is not limited to these Examples. Meanwhile, unless otherwise noted, “part” and “%” are based on mass (part by mass and % by mass), and the particle diameter is the volume average particle diameter.

### Example 1

### Preparation of Paper Base Material

Wood pulp of LBKP (bleached pulp of a broad-leaved tree) was beaten to a Canadian freeness of 300 cc by a double disk refiner. To 100 parts of the pulp material, 1.0 part of cationic starch, 0.5 parts of alkylketene dimer, 0.5 parts of epoxidized fatty acid amide, 0.3 parts of polyamine polyamide epichlorohydrin, 0.03 parts of a higher fatty acid ester and 0.02 parts of colloidal silica were added, from which base paper having a basis weight of 128 g/m² was made with a Fourdrinier. The thickness of the product was adjusted to from 121 to 136 μm (density: 1.06 to 0.94) using a calender to form a paper base material.

[Production of Peelable Adhesive Sheet]

To 65 parts of water, 60 parts of hollow particles HP-1055 (particle diameter: 1.0 μm, hollowness ratio: 55%, manufactured by Rohm and Haas) and 25 parts of starch (75A, manufactured by GLICO FOODS) were added, and the resulting mixture was dispersed sufficiently. After that, 100 parts of an acrylic latex AE120A (acrylic resin, Tg=−10° C., volume average particle diameter: 55 nm, total solid content: 36.5%, manufactured by JSR) were added to and mixed with the dispersed mixture, and a coating liquid for forming an adhesive composition layer was obtained.

The prepared coating liquid was coated on one side of the paper having the basis weight of 128 g/m² made as above so as to give a coating amount of 6 0g/m² in a solid content by a bar coater method, and the coating was then dried at 80° C. for 3 minutes. Thus, the peelable adhesive sheet was obtained.

### Example 2

The peelable adhesive sheet was obtained in the substantially same manner as in Example 1, except for using AE337 (acrylic resin, Tg=−30° C., volume average particle diameter 250 nm; total solid content: 48.5%, manufactured by JSR) in place of the acrylic latex AE120A, and changing the amount of water so that a solid content of the coating liquid obtained in Examples 2 is the same as that of Example 1.

### Example 3

The peelable adhesive sheet was obtained in the substantially same manner as in Example 1, except for using SX8900B (acrylic resin, Tg=+20° C., volume average particle diameter: 55 nm, total solid content: 35%, manufactured by JSR) in place of the acrylic latex AE120A, and changing the amount of water so that a solid content of the coating liquid obtained in Examples 3 is the same as that of Example 1.

### Example 4

The peelable adhesive sheet was obtained in the substantially same manner as in Example 1, except for using AF-1353 (particle diameter: 1.3 μm, hollowness ratio: 53%, manufactured by Rohm and Haas) in place of the hollow particles HP-1055.

### Example 5

The peelable adhesive sheet was obtained in the substantially same manner as in Example 1, except for using HP-433J (particle diameter: 0.4 μm, hollowness ratio: 33%, manufactured by Rohm and Haas) in place of the hollow particles HP-1055.

### Example 6

The peelable adhesive sheet was obtained in the substantially same manner as in Example 1, except for using SX866(C) (particle diameter: 0.3 μm, hollowness ratio: 30%, manufactured by JSR) in place of the hollow particles HP-1055.

### Example 7

The peelable adhesive sheet was obtained in the substantially same manner as in Example 1, except for using SX868(B) (particle diameter: 0.5 μm, hollowness ratio: 40%, manufactured by JSR) in place of the hollow particles HP-1055.

### Example 8

The peelable adhesive sheet was obtained in the substantially same manner as in Example 1, except for using SX8732(D) (particle diameter: 1.0 μm, hollowness ratio: 50%, manufactured by JSR) in place of the hollow particles HP-1055.

### Example 9

The peelable adhesive sheet was obtained in the substantially same manner as in Example 1, except for using SX8732(A) (particle diameter: 1.1 μm, hollowness ratio: 55%, manufactured by JSR) in place of the hollow particles HP-1055.

### Example 10

The peelable adhesive sheet was obtained in the substantially same manner as in Example 1, except for using TOCRYL N-140EC-2 (acrylic resin, Tg=−20° C., total solid content: 39.5%, manufactured by Toyo Ink Mfg Co., Ltd.) in place of the acrylic latex AE120A, and changing the amount of water so that a solid content of the coating liquid obtained in Examples 10 is the same as that of Example 1.

### Example 11

The peelable adhesive sheet was obtained in the substantially same manner as in Example 1, except for using TOCRYL W-251-4 (acrylic resin, Tg=+12° C., total solid content: 45%, manufactured by Toyo Ink Mfg Co., Ltd.) in place of the acrylic latex AE120A, and changing the amount of water so that a solid content of the coating liquid obtained in Examples 11 is the same as that of Example 1.

### Comparative Example 1

To 65 parts of water, 60 parts of silica (CARPLEX FPS101, particle diameter: 1.2 μm, manufactured by Degussa Japan) and 25 parts of starch (75A, manufactured by GLICO FOODS) was added and dispersed sufficiently. To this mixture, 100 parts of a natural rubber-based latex formed by mixing natural rubber and methyl methacrylate were added and mixed, and a coating liquid for forming an adhesive composition layer was obtained.

The prepared coating liquid was coated on one side of the paper having the basis weight of 128 g/m² made as above so as to give a coating amount of 6.0 g/m² in a solid content by a bar coater system, and a peelable adhesive sheet was obtained.

### Comparative Example 2

A peelable adhesive sheet was obtained in the substantially same manner as in Comparative Example 1, except for using the hollow particles HP-1055 (particle diameter: 1.0 μm, hollowness ratio: 55%, manufactured by Rohm and Haas) in place of the silica.

### Comparative Example 3

A pressure-adhering sheet was obtained in the substantially same manner as in Comparative Example 1, except for using an acrylic latex AE120A (acrylic resin, Tg=−10° C., volume average particle diameter: 55 nm, manufactured by JSR) in place of the natural lubber-based latex.

### Comparative Example 4

A peelable adhesive sheet was obtained in the substantially same manner as in Comparative Example 1, except for using a styrene/butadiene-based latex 0696 (Tg=−12° C., volume average particle diameter: 170 nm, manufactured by JSR) in place of the natural lubber-based latex.

### Comparative Example 5

A peelable adhesive sheet was obtained in the substantially same manner as in Example 1, except for using an acrylic crosslinked particles SX8743(A)-02 (particle diameter: 0.2 μm, manufactured by JSR) in place of the hollow particles HP-1055.

### Comparative Example 6

A peelable adhesive sheet was obtained in the substantially same manner as in Example 1, except for using a polystyrene-based particles SX1302 (particle diameter: 0.12 μm, manufactured by ZEON Corporation) in place of the hollow particles HP-1055.

<Evaluation of Pressure-Adhering Performance>

The peelable adhesive sheets obtained as above were placed under a prescribed environment (23° C., 50% RH) for 24 hours, and then cut into a size (200 mm×148 mm) of twofold postcard (V type postcard), which was folded into two parts so that the adhesive composition layers face with each other and the size of each of the two part is the size of a postcard (100 mm×148 mm), and the adhesive composition layer of one part contacted the adhesive composition layer of the other part.

A pouch laminator DS320P (GBC JAPAN) was previously adjusted so that the temperature at the heating portion was 60° C. The tip of the folded portion of the sheet was inserted into the insertion opening of the laminator and the adhesive composition layers were adhered to each other.

After leaving the resulting material under the same environment for three hours, the state of the adhesiveness (pressure adhering) at the time of separating the adhered surfaces was evaluated based on the following evaluation criteria. Results are shown in Table 1. Meanwhile, in the invention, B or higher denotes that the level is allowable.

Evaluation Criteria

A: At the time of separating the adhered surfaces, adhesiveness was extremely good.

A-B: At the time of separating the adhered surfaces, adhesiveness was good.

B: At the time of separating the adhered surfaces, adhesiveness was somewhat weak.

C: At the time of separating the adhered surfaces, adhesiveness was almost absent (easily separated).

<Evaluation of Glossy Feeling>

Using a color printer DOCUCOLOR1250 PF (an electrophotographic printer of a heat roll system, manufactured by Fuji Xerox Co., Ltd.), a photographic image was output on the adhesive composition layer of the peelable adhesive sheet obtained as above to form an image.

In the same manner as that in the evaluation of pressure-adhering performance, the peelable adhesive sheet was placed in a prescribed environment (23° C., 50% RH) for 24 hours, and then cut into a size (200 mm×148 mm) of twofold postcard (V type postcard), which was folded into two parts so that the adhesive composition layers face with each other and the size of each of the two part is the size of a postcard (100 mm×148 mm), and the adhesive composition layer of one part contacted the adhesive composition layer of the other part.

A pouch laminator DS320P (GBC JAPAN) was previously adjusted so that the temperature at the heating portion was 60° C. The tip of the folded portion of the sheet was inserted into the insertion opening of the laminator and the adhesive composition layers were adhered to each other.

After leaving the resulting material under the same environment for three hours, the glossy feeling of the whole image upon separating the adhered adhesive composition layers (an image forming layer) was visually observed and evaluated based on the following evaluation criteria. Results are shown in Table 1. Meanwhile, in the invention, B or more denotes that the level is allowable.

Evaluation Criteria

A: There was little difference in gloss (irregularity in gloss) in the image.

A-B: Difference in gloss (irregularity in gloss) in the image was small.

B: Difference in gloss (irregularity in gloss) in the image was somewhat conspicuous.

B-C: Difference in gloss (irregularity in gloss) in the image was conspicuous and at a practically problematic level.

C: Difference in gloss (irregularity in gloss) in the image was great.

TABLE 1

| | | | Particle filler | | | | |
|---|---|---|---|---|---|---|---|
| | | | | Volume average | Hollow | | |
| | Resin | | | particle | Ratio | | Glossy |
| | Kind | Tg (° C.) | Kind | diameter (μm) | (%) | Adhesiveness | feeling |
| Example 1 | acrylic | −10 | hollow particle | 1.0 | 55 | A | A |
| Example 2 | acrylic | −30 | hollow particle | 1.0 | 55 | A | A-B |
| Example 3 | acrylic | +20 | hollow particle | 1.0 | 55 | A-B | A |
| Example 4 | acrylic | −10 | hollow particle | 1.3 | 53 | A | A |
| Example 5 | acrylic | −10 | hollow particle | 0.4 | 33 | A | A-B |
| Example 6 | acrylic | −10 | hollow particle | 0.3 | 30 | A | A-B |
| Example 7 | acrylic | −10 | hollow particle | 0.5 | 40 | A | A |
| Example 8 | acrylic | −10 | hollow particle | 1.0 | 50 | A | A |
| Example 9 | acrylic | −10 | hollow particle | 1.1 | 55 | A | A |
| Example 10 | acrylic | −20 | hollow particle | 1.0 | 55 | A | A |
| Example 11 | acrylic | +12 | hollow particle | 1.0 | 55 | A | A |
| Comparative Example 1 | natural rubber latex | — | silica | 1.2 | — | B | C |
| Comparative Example 2 | natural rubber latex | — | hollow particle | 1.0 | 55 | A-B | B-C |
| Comparative Example 3 | acrylic | −10 | silica | 1.2 | — | B | C |
| Comparative Example 4 | styrene/butadiene latex | −12 | silica | 1.2 | — | B | C |
| Comparative Example 5 | acrylic | −10 | acrylic cross-linked particle | 0.2 | — | B | C |
| Comparative Example 6 | acrylic | −10 | polystyrene-based particle | 0.12 | — | B | C |

As shown in Table 1, in the peelable adhesive sheet of the invention, the generation of the adhesion failure is suppressed. It can also be seen that, in the peelable adhesive sheet of the invention, the generation of adhesion failure is suppressed even when an image is formed with an electrophotographic printer, and that an image imparting a good impression of glossiness even after separating the adhered surfaces can be formed.

According to the invention, it is possible to provide a peelable adhesive sheet in which the generation of the adhesion failure is suppressed and a recorded image imparting a good impression of glossiness can be formed.

Hereinafter exemplary embodiments of the present invention will be listed. However, the present invention is not restricted to the following exemplary embodiments.

<1> A peelable adhesive sheet comprising a base material and an adhesive composition layer that is provided to at least one side of the base material and that contains an acrylic resin and hollow particles, wherein the adhesive composition layer is configured to removably adhere to another adhesive layer when at least two adhesive composition layers at least partially contact each other and at least pressure is applied thereto.

<2> The peelable adhesive sheet according to <1>, wherein the glass transition temperature Tg of the acrylic resin is from −40° C. to +30° C.

<3> The peelable adhesive sheet according to <1>, wherein the glass transition temperature Tg of the acrylic resin is from −20° C. to +15° C.

<4> The peelable adhesive sheet according to any one of <1> to <3>, wherein a hollowness ratio of the hollow particles defined by (inner diameter of a hollow particle/outer diameter of a hollow particle)×100 (%) is from 20% to 95%.

<5> The peelable adhesive sheet according to any one of <1> to <3>, wherein a hollowness ratio of the hollow particles defined by (inner diameter of a hollow particle/outer diameter of a hollow particle)×100 (%) is from 30% to 70%.

<6> The peelable adhesive sheet according to any one of <1> to <5>, wherein the volume average particle diameter of the acrylic resin is from 30 nm to 200 nm.

<7> The peelable adhesive sheet according to any one of <1> to <6>, wherein the volume average particle diameter of the hollow particles is from 0.3 μm to 3 μm.

<8> The peelable adhesive sheet according to any one of <1> to <7>, wherein the content ratio of the acrylic resin and the hollow particles (acrylic resin : hollow particles) is from 80:20 to 10:90, based on mass.

<9> The peelable adhesive sheet according to any one of <1> to <8>, wherein the acrylic resin is a carboxy-modified acrylic resin.

<10> The peelable adhesive sheet according to any one of <1> to <9>, wherein the base material is a paper base material having opacity of 85% or more and a basis weight of from 64 to 210 g/m².

<11> A method for recording an image comprising recording an image on the adhesive composition layer of the peelable adhesive sheet according to any one of <1> to <10>, using an electrophotographic printer of a heat roll fixing system.

<12> A method for manufacturing a peelable laminated body comprising:

placing the adhesive composition layers, each of which is provided on or above the base material of the peelable adhesive sheet according to any one of <1> to <10>, so as that they overlap; and

applying at least one of heat or pressure from the side of the base material opposite to the side on which the overlapped adhesive composition layers are provided, to adhere the adhesive composition layers to each other at a temperature of 70° C. or less.

<13> The method of manufacturing a peelable laminated body according to <12>, wherein the peelable adhesive sheet is folded into two parts and the adhesive composition layer of one of the two parts contacts the adhesive composition layer of the other part.

<14> The method of manufacturing a peelable laminated body according to <12>, wherein the adhesive composition layer is provided on both sides of the base paper, and the peelable adhesive sheet is folded into three parts such that the adhesive composition layers on adjacent two parts on one side of the peelable laminated sheet are overlapped on each other and the adhesive composition layers on two adjacent parts on the other side of the peelable laminated sheet at least partially contact each other.

All publications, patent applications, and technical standards mentioned in this specification were herein incorporated by reference to the same extent as if each individual publication, patent application, or technical standard was specifically and individually indicated to be incorporated by reference.

What is claimed is:

1. A peelable adhesive sheet comprising a base material and an adhesive composition layer that is provided to at least one side of the base material and that contains an acrylic resin and hollow particles, wherein the adhesive composition layer is configured to removably adhere to another adhesive layer when at least two adhesive composition layers at least partially contact each other and at least pressure is applied thereto.

2. The peelable adhesive sheet according to claim 1, wherein the glass transition temperature Tg of the acrylic resin is from −40° C. to +30° C.

3. The peelable adhesive sheet according to claim 1, wherein the glass transition temperature Tg of the acrylic resin is from −20° C. to +15° C.

4. The peelable adhesive sheet according to claim 1, wherein a hollowness ratio of the hollow particles defined by (inner diameter of a hollow particle/outer diameter of a hollow particle)×100 (%) is from 20% to 95%.

5. The peelable adhesive sheet according to claim 1, wherein a hollowness ratio of the hollow particles defined by (inner diameter of a hollow particle/outer diameter of a hollow particle)×100 (%) is from 30% to 70%.

6. The peelable adhesive sheet according to claim 1, wherein the volume average particle diameter of the acrylic resin is from 30 nm to 200 nm.

7. The peelable adhesive sheet according to claim 1, wherein the volume average particle diameter of the hollow particles is from 0.3 μm to 3 μm.

8. The peelable adhesive sheet according to claim 1, wherein the content ratio of the acrylic resin and the hollow particles (acrylic resin: hollow particles) is from 80:20 to 10:90, based on mass.

9. The peelable adhesive sheet according to claim 1, wherein the acrylic resin is a carboxy-modified acrylic resin.

10. The peelable adhesive sheet according to claim 1, wherein the base material is a paper base material having opacity of 85% or more and a basis weight of from 64 to 210 g/m².

11. A method for recording an image comprising recording an image on the adhesive composition layer of the peelable adhesive sheet according to claim 1 using an electrophotographic printer of a heat roll fixing system.

12. A method for manufacturing a peelable laminated body comprising:
placing the adhesive composition layers, each of which is provided on or above the base material of the peelable adhesive sheet according to claim 1, so that they overlap; and
applying at least one of heat or pressure from the side of the base material opposite to the side on which the overlapped adhesive composition layers are provided, to adhere the adhesive composition layers to each other at a temperature of 70° C. or less.

13. The method of manufacturing a peelable laminated body according to claim 12, wherein the peelable adhesive sheet is folded into two parts and the adhesive composition layer of one of the two parts contacts the adhesive composition layer of the other part.

14. The method of manufacturing a peelable laminated body according to claim 12, wherein the adhesive composition layer is provided on both sides of the base paper, and the peelable adhesive sheet is folded into three parts such that the adhesive composition layers on two adjacent parts on one side of the peelable laminated sheet at least partially contact each other, and the adhesive composition layers on two adjacent parts on the other side of the peelable laminated sheet at least partially contact each other.
